(19) United States
(12) Patent Application Publication
(10) Pub. No.: US 2007/0039933 A1
(43) Pub. Date: Feb. 22, 2007

(54) System and method of laser dynamic forming

(76) Inventor: Gary J. Cheng, Houston, TX (US)

Correspondence Address: PERKINS COIE LLP;PATENT-SEA, P.O. BOX 1247, SEATTLE, WA, 98111-1247, US

(21) Appl. No.: 11/507,064

(22) Filed: Aug. 18, 2006

Related U.S. Application Data
(60) Provisional application No. 60/709,592, filed on Aug. 18, 2005.

(51) Int. Cl. B23K 26/36

(52) U.S. Cl. 219/121.69

(57) ABSTRACT

A system and method for forming micro- and meso-scale features in ductile and brittle surfaces. One or more laser pulses are applied to an ablative coating on a workpiece. The laser pulses cause the coating to ablate and plasma to be created in a space between a confining medium and the workpiece. The creation of plasma within the confined space generates a shockwave that deforms the workpiece, ultimately shaping the workpiece to an underlying mold. The number of laser pulses that are applied to shape a workpiece depends on the composition and thickness of the workpiece, type of laser, composition and thickness of ablative and confining material, and amount of desired deformation. For some materials, the workpiece may be preheated before being deformed.

### CROSS REFERENCE TO RELATED APPLICATIONS

This application claims priority to U.S. Provisional Patent Application No. 60/709,592, filed 18 Aug. 2005, entitled “LASER DYNAMIC FORMING FOR MICRO- AND MESO-SCALE 3D SHAPES.”

### TECHNICAL FIELD

This invention relates to microscale forming technologies, and more particularly, to microscale forming technologies using lasers.

### BACKGROUND

The need to manufacture microscale objects, or objects having features greater than one micrometer (one millionth of a meter or 1 μm) in size, is of growing importance in order to bridge the gap between devices manufactured in the nano- and macro-worlds. Many of today's miniaturization initiatives will require accurate and repeatable microscale manufacturing methods in order to successfully commercialize emerging applications in industries such as electronics, healthcare, automobiles, environmental monitoring, etc. To overcome commercialization barriers, it is important that any micromanufacturing processes be inexpensive, quick, repeatable, and work with a broad range of materials.

Unfortunately, many of the current micromanufacturing processes have one or more shortcomings that limit their broad applicability. One class of solutions utilizes lithographic processes for the manufacture of microscale objects. Because lithographic manufacturing is based on the projection of parallel sets of two-dimensional patterns on a workpiece, the resulting objects that can be manufactured have only a quasi three-dimensional shape and certain three-dimensional objects cannot be formed. Moreover, most lithographic micromanufacturing only works on a limited selection of materials that are silicon based. A second class of solutions include stamping, high strain rate forming, and laser forming. Each of these techniques has their own advantages and disadvantages. For example, these techniques are typically limited to metals as the workpiece material, may require significant expense for tooling and fixtures, and may have limitations on the formability of microscale objects because of size effects (such as wrinkling, springback, etc.). Both lithographic and non-lithographic micromanufacturing solutions have particular shortcomings when applied to brittle and other hard-to-form materials. It will therefore be appreciated that an inexpensive, quick, and repeatable method to produce three-dimensional shapes at the microscale level would be beneficial, particularly for brittle and hard-to-form materials.

### BRIEF DESCRIPTION OF THE DRAWINGS

FIG. 1 is a cross-sectional view of a workpiece and a schematic representation of a laser dynamic forming system prior to the start of a laser dynamic forming process.

FIG. 2 is a flow chart of steps in the laser dynamic forming process.

FIG. 3 is a cross-sectional view of the workpiece in FIG. 1 after the laser dynamic forming process has been started.

FIG. 4 is a cross-sectional view of the workpiece in FIG. 1 after the laser dynamic forming process has been completed.

FIG. 5 is a perspective view of a microscale structure fabricated using the laser dynamic forming process.

### DETAILED DESCRIPTION

A system and method for forming micro- and meso-scale features in ductile and brittle surfaces is disclosed. A workpiece is prepared for forming by coating the surface of the workpiece with an ablative coating. A confining medium is placed over the ablative coating, and the workpiece is positioned so that the ablative coating may receive a laser pulse. A mold of the desired feature that is to be formed is placed against the surface of the workpiece that is opposite the ablative coating. One or more laser pulses are applied to the ablative coating through the confining medium, causing the coating to ablate and plasma to be created in the space between the confining medium and the workpiece. The creation of plasma within the confined space generates a shockwave that deforms the workpiece, ultimately shaping the workpiece to the underlying mold. The number of laser pulses that are applied to shape a workpiece depends on the composition and thickness of the workpiece, type of laser, composition and thickness of ablative and confining material, and amount of desired deformation. The disclosed method is a simple and repeatable technique to create micro- and meso-scale features.

In some embodiments, the workpiece is preheated prior to laser pulses being applied to the ablative material or coincident with the laser pulses being applied. Preheating the workpiece may be advantageous when the workpiece is brittle, since the workpiece may be more easily shaped when it is close to or within a ductile temperature range. The workpiece may be preheated using a continuous laser that is applied to the workpiece. Alternatively, a heating block, heating coil, microheater, or other similar component may be used alone or in conjunction with the continuous laser to heat the workpiece prior to forming.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

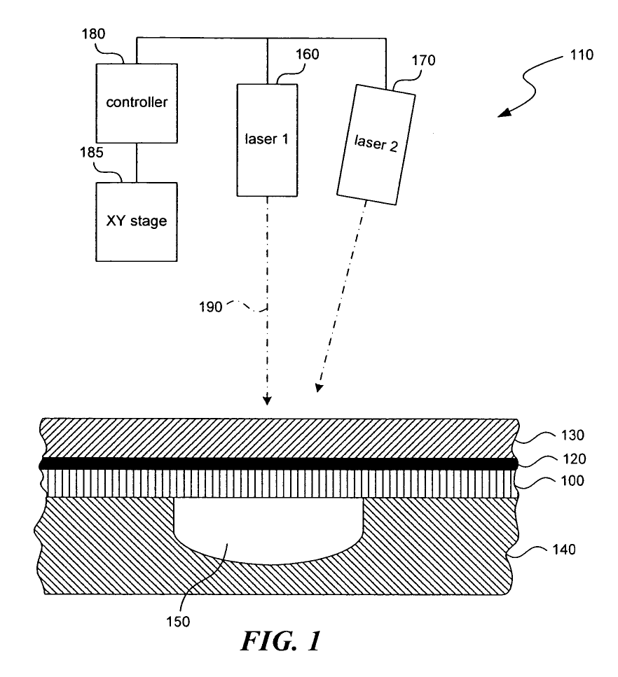

FIG. 1 is a cross-sectional view of a workpiece 100 and a schematic representation of a laser dynamic forming system 110 prior to the start of a laser dynamic forming process. On one surface, the workpiece 100 is coated with an ablative coating 120 and a confining medium 130. On the other surface, the workpiece 100 is placed adjacent a mold 140 that contains a cavity 150 corresponding to the desired micro- and/or meso-scale feature that is to be formed. The workpiece and mold are secured in a fixture (not shown) to prevent movement. A first laser 160 is positioned in a manner that allows laser pulses to be applied to the workpiece. A second laser 170 is optionally provided and positioned in a manner that allows it to preheat the workpiece. As will be described in additional detail below, a controller 180 causes the first laser 160 to apply one or more pulses to the workpiece. The ablative material is ablated by the laser pulses, and the resulting plasma shockwave causes the workpiece to be deformed until it is formed into a desired feature by the underlying mold. Each component in the laser dynamic forming system and the use of each component in the overall process will now be addressed in turn.

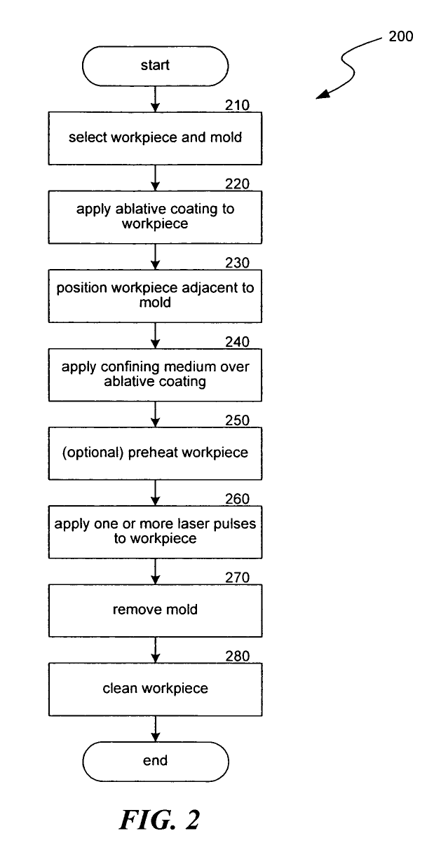

FIG. 2 is a flowchart of a laser dynamic forming process 200 implemented by the system 110. At a block 210, a workpiece 100 and a corresponding mold 140 are selected by an operator. The workpiece is a piece of material that is to be shaped by the laser dynamic forming system into a desired form. The workpiece may be any of a wide range of materials including many that are brittle and hard-to-form with traditional micromanufacturing techniques. For example, copper foil and silicon workpieces that are approximately 20 microns thick have been successfully shaped into three-dimensional microscale objects using the laser dynamic forming process disclosed herein. The composition and thickness of a workpiece is only limited by the strength of the plasma-induced shockwave that deforms the workpiece. The disclosed system and method is not limited in the composition or thickness of workpiece material to which it is applied.

A mold 140 is selected that has a desired shaped cavity 150 into which the workpiece is to be formed. The mold may be created using a variety of different techniques depending on the scale of the desired workpiece features. For example, in meso-scales, milling may be used to create mold cavities in steel. In micro-scales, photochemically machinable glass may be used to fabricate micro-dies by photolithography and anisotropic etching. Those skilled in the art will appreciate that many other techniques that are capable of creating mold cavities of the desired scale may be suitable for the disclosed system and method.

At a block 220, the workpiece is coated on one surface with an ablative coating 120. The ablative coating is converted into a plasma when a pulsed laser is applied, creating a shockwave that deforms the workpiece. The composition and thickness of the ablative coating used on the workpiece depends on the type of laser, the workpiece composition and thickness, the heat and pressure that is intended to be created to deform the workpiece, and the size of the intended feature to be formed. For example, when forming micro-scale features on a copper sheet, the ablative coating layer may be black organic paint. When forming micro-scale features on a silicon sheet, the ablative coating layer may be a thin metal foil or film such as aluminum or copper. The film may be sputtered onto the workpiece or applied by chemical vapor deposition (CVD). In some cases, graphite may be used as an ablative coating. The thickness of the applied ablative coating depends on the desired plasma heat and pressure when the material is ablated by the laser. For example, a 20-40 micron thick coating of black paint may be required on a 20 micron copper workpiece, but only a 15 micron thick metal thin film may be required on the same workpiece. If the workpiece is to be pre-heated in order to soften the material, it may be necessary to select an ablative coating having a higher melting temperature than the associated workpiece.

At a block 230, the ablative-coated workpiece 100 is placed on the mold and secured with a fixture that prevents the workpiece from shifting during the laser dynamic forming process. The side of the workpiece with the ablated coating is placed towards the first laser 160, and the mold is secured on the opposite side of the workpiece. Preferably, the workpiece is in close proximity with the mold. Those skilled in the art will appreciate that a variety of fixtures exist for releasably securing the workpiece and mold to prevent movement. If a significant portion of the workpiece is to be formed using the techniques described herein, the fixture may include an automated XY stage 185 that is driven by the controller 180. Mounting the workpiece to an XY stage enables the workpiece to be moved within an X and Y coordinate system under computer control in order to apply laser dynamic forming to various portions of the workpiece.

At a block 240, a confining medium 130 is applied over the ablative coating 120. The purpose of the confining medium is to restrict the diffusion of the plasma and primarily direct the plasma shockwave towards the workpiece. The composition and thickness of the confining medium used on the workpiece depends on the type of laser, the workpiece composition and thickness, the heat and pressure that is intended to be created to deform the workpiece, and the size of the intended feature to be formed. For example, the workpiece and ablative coating may be immersed in water which acts as the confining medium. Alternatively, a sheet of silicon dioxide (SiO₂) glass may be placed over or glued onto the ablative coating and secured to the workplace and the mold. As another example, compressed air may be utilized to create a reflective layer that redirects the plasma shockwave towards the workpiece. The selection of a confining medium will depend in part on the laser or lasers utilized by the system, as the confining medium preferably allows a laser pulse or a continuous laser to pass through the confining medium without a significant loss of power.

At a block 250, the workpiece 100 is optionally preheated. While most workpieces made of ductile materials will not require preheating, those workpieces that are brittle may require preheating prior to or during the forming process. Preheating a workpiece to a point where the workpiece is at or near to a ductile temperature range allows the workpiece to be more easily formed with less damaging artifacts as a result of the forming process. For example, a silicon workpiece may be heated to above 850K to increase its dislocation mobility. In some embodiments, the workpiece may be preheated using a continuous wave (CW) laser that is applied to the workpiece. The CW laser may be any wavelength, provided that the confining medium that is selected is largely optically transparent to the wavelength of the selected laser. Types of CW lasers that may be utilized include a Neodymium Yttrium Aluminum Garnet (Nd-YAG) laser, as well as other lasers such as Carbon Dioxide (CO₂), Titanium Sapphire, Argon Ion, Krypton Ion, or Diode. Other preheating methods may be used in place of or in conjunction with a CW laser, including a heating block, heating coil, microheater, or other similar component in close proximity to the workpiece. Such additional preheating methods may be utilized in combination with the laser preheating for particularly brittle materials. The length of preheating may vary significantly, depending on the heating method being used and the workpiece composition. In some cases, the preheating may take a significant period before laser forming pulses are applied to the workpiece. In other cases, the preheating may be nearly instantaneous and may be applied simultaneously with or very close to the period when laser forming pulses are applied to the workpiece. Those skilled in the art will appreciate that the selected workplace material will have a unique ductile temperature profile, and any type of heater may be utilized in the disclosed system and method to achieve a desired temperature within that profile.

After the ablative coating 120 has been applied to the workpiece 100 and the workpiece appropriately positioned between the mold 140 and the confining medium 130, the workpiece is ready to be formed. At a block 260, the controller causes the first laser 160 to apply one or more laser pulses 190 to the workpiece. The first laser is preferably a pulsed laser having a wavelength that allows the emitted laser pulses to pass through the confining medium 130 without a significant loss of power. The first laser is selected so that the emitted laser beam interacts with the ablative coating 120 to form a plasma that creates a desired shockwave to deform the workpiece. The specific power requirements and pulse duration of the first laser 160 are dependent on the composition and thickness of the confining medium, the composition and thickness of the ablative material, the composition and thickness of the workpiece, and the degree of desired workpiece deformation. While any laser that meets the necessary power level and pulse durations may be utilized in the disclosed system and method, lasers that have a high peak power (>1MW) and a reasonable pulse duration (>100 fs) have been found to be particularly suitable. For example, when forming a workpiece of silicon, a Nd-YAG laser with a peak intensity of 2 GW/cm² and pulse duration of ˜10 ns was found to take between one and five pulses to deform the workpiece to a desired shape. As another example, when forming a silicon workpiece of 20 micron thickness with a 15 micron metal foil ablative coating, a Nd-YAG laser with a peak intensity of 2 GW/cm² and pulse duration of ˜10 ns was found to take five pulses to deform the workpiece to a desired three-dimensional shape. It has been experimentally found that as the pulse duration increases from 10 to 50 ns, the strain rate decreases and consequently the rate of dislocation multiplication decreases. As a result, longer pulse rates may be preferable when attempting to control the microstucture of dislocations. Those skilled in the art will appreciate that the appropriate pulse power and duration may be calculated based on the selected workpiece, ablative material and thickness, and desired form.

FIGS. 1, 3, and 4 depict a cross-section of the workpiece as the laser dynamic forming process is applied to the workpiece. FIG. 1 depicts the workpiece before the dynamic forming process has started. The workpiece 100 is in its beginning state, and the ablative coating 120 and confining medium 130 are appropriately positioned for the process to begin. The workpiece may or may not have been preheated by the second laser 170, depending on the workpiece composition, workpiece thickness, and the amount of deformation that is to occur. When the laser dynamic forming process is initiated, the controller causes the first laser 160 to apply one or more pulses with a laser beam 190 to the ablative coating. The laser pulses cause the coating to ablate and plasma to be created in the space between the confining medium 130 and the workpiece 100.

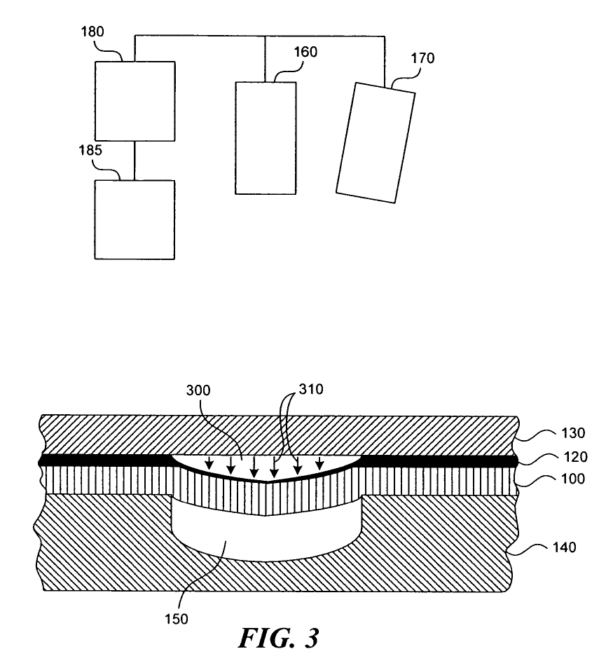

FIG. 3 depicts a cross-section of the workpiece at a point part-way through the laser dynamic forming process. A portion of the ablative coating that has been exposed to the laser pulses has ablated and formed a plasma in a space 300 between the workpiece and the confining medium 130. The plasma may continue to absorb energy in the laser pulse as the pulse is applied. Under these conditions, the plasma that is formed is inherently at a high temperature and a high pressure. The high temperature of the plasma acts to heat the workpiece (or further heat the workpiece if the workpiece has been preheated). The high pressure generated by the plasma creates a shockwave that is represented by force vectors 310 in FIG. 3. The strength of the shockwave will vary depending on the applied laser pulse, ablative coating, and confining medium. As an example, for a dense confining medium, such as silicon dioxide glass, shock pressures can reach 16-26 GPa or more. For a less dense confining medium, such as water, shock pressures that result from an identical laser pulse may only reach 1.7-3.5 GPa. The shockwave exerts a force on the workpiece 100, causing the workpiece to deform in a direction away from the confining medium. Those areas of the workpiece that are not flush with the mold, such as areas adjacent to the mold cavity 150, are deformed. Those areas of the workpiece that are flush with the mold 140 are not appreciably deformed. As depicted in FIG. 3, as a result of the plasma shockwave the workpiece has started to deform into the mold cavity. Note that the force vectors 310 in FIG. 3 are idealized representations of the force that is applied to the workpiece, and are used for illustrative purposes only. The actual force vectors may be unequally distributed across the workpiece, and may be oriented in a non-uniform manner (although generally toward the workpiece).

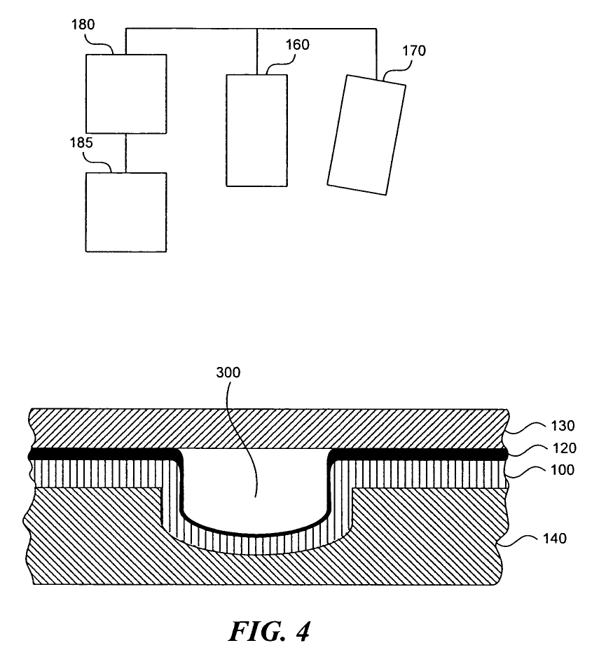

FIG. 4 depicts a cross-section of the workpiece at the conclusion of the laser dynamic forming process. One or more laser pulses have been applied by the laser 160 to the workpiece for the workpiece to have reached the final state depicted in FIG. 4. Portions of the workpiece 100 have been deformed by the plasma shockwave until those portions have come into contact with the walls of the mold. Further deformation is halted by walls of the mold, causing the deformed portion of the workpiece to take on the shape of the mold cavity. The space 300 between the workpiece and the confining medium has expanded as a result of the plasma generation. Some of the ablative layer 120 may remain on the formed portion of the workpiece as a result of incomplete ablation. It will be appreciated that FIGS. 1, 3, and 4 are intended for illustrative purposes only. The actual shape and final form of the workpiece will vary from those shown in the figures, which are an idealized representation of the process.

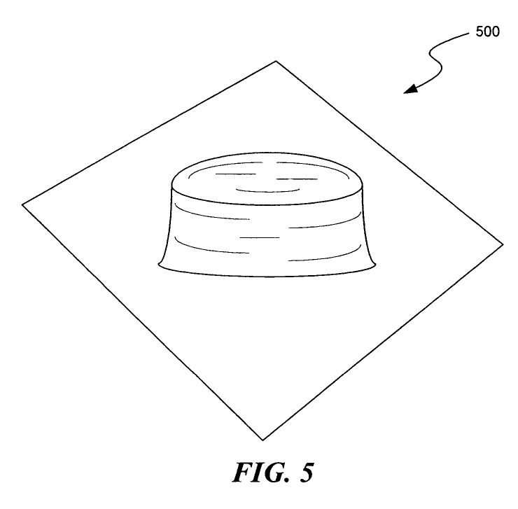

Returning to FIG. 2, the workpiece may be repositioned a number of times and the laser dynamic forming process reapplied to form the workpiece into a desired shape. Such repositioning may be done manually, or may be done under computer control using the XY stage 185 to move the workpiece appropriately. After workpiece forming is complete, at a block 270 the mold is removed. At a block 280, the workpiece is cleaned to remove any ablative material that remains on the workpiece. FIG. 5 is perspective view of a workpiece 500 that has been formed using the laser dynamic forming process. The workpiece has taken on the inverse three-dimensional shape of the mold cavity in which it was formed. It will be appreciated that the laser dynamic forming process disclosed herein enables such shapes to be created even for brittle or other hard-to-form materials. Such a process may be particularly useful in various applications such as ceramic deformation, microchannels, nanochannels, microfluidics, MEMS components, and sensors and actuators.

It will be appreciated that although the majority of the discussion above relates to micro- and meso-scale forming, the techniques disclosed herein may be applicable to the manufacture of certain forms at a nano-scale. Extension of the process to the nano-scale may entail different techniques to construct the mold used in the forming process, but otherwise many of the same analyses and trade-offs apply to the process. It will also be appreciated that while the term “plasma” is used throughout to refer to the byproduct of the ablation process, plasma includes ionized gas, any quasineutral collection of charged particles, or any other composition of matter that is a result of the ablation fo the ablative coating by the laser pulse.

From the foregoing, it will be appreciated that specific embodiments of the invention have been described herein for purposes of illustration, but that various modifications may be made without deviating from the spirit and scope of the invention. For example, while the laser dynamic forming process described above contemplates that the workpiece is shaped by being forced by a plasma shockwave into a mold cavity, in an alternative embodiment the position of the mold and the workpiece could be reversed and the mold could be forced into the workpiece by a plasma shockwave. That is, the ablative coating could be applied to one surface of the mold and the other surface of the mold placed against the workpiece. A laser pulse that is applied to the ablative coating thereby produces a shockwave that drives the mold into the workpiece. Changing the order of the workpiece layers in this fashion would result in the workpiece being “stamped” into a desired form by the mold. Accordingly, the invention is not limited except as by the appended claims.

I/We claim:

1. A method of forming a desired feature on a workpiece using a laser, the method comprising:
layering an ablative material on a surface of a workpiece;
applying a confining medium over the ablative material;
positioning a surface of the workpiece that is opposite the surface with ablative material in proximity to a mold having a desired feature; and
applying a laser pulse to the ablative material, wherein the laser pulse ablates at least a portion of the ablative material and generates a shockwave that is applied to the workpiece and forms the workpiece to the mold to create the desired feature.

2. The method of claim 1, wherein the ablative material is paint.

3. The method of claim 1, wherein the ablative material is a thin film.

4. The method of claim 1, further comprising heating the workpiece prior to application of the laser pulse.

5. The method of claim 1, further comprising heating the workpiece during application of the laser pulse.

6. The method of claim 5, wherein the workpiece is heated with a continuous wave laser beam.

7. The method of claim 5, wherein the workpiece is heated with a heater.

8. The method of claim 1, wherein the confining medium is nearly optically transparent to the wavelength of the laser pulse.

9. The method of claim 8, wherein the confining medium is a liquid.

10. The method of claim 8, wherein the confining medium is glass.

11. The method of claim 1, further comprising applying a plurality of laser pulses to the ablative material.

12. The method of claim 11, further comprising moving the workpiece in an XY coordinate plane as the plurality of laser pulses are applied.

13. A system for forming a desired feature on a workpiece using a laser, the system comprising:
a mold formed with a desired feature;
a fixture for holding the mold in a fixed position relative to a workpiece, wherein the workpiece is layered with an ablative material on a surface of the workpiece and a confining medium over the ablative material;
a pulse laser for generating laser pulses; and
a controller coupled to the pulse laser and controlling the pulse laser to generate a laser pulse that is applied to the ablative material, wherein the laser pulse ablates at least a portion of the ablative material and generates a shockwave that is applied to the workpiece and that forms the workpiece to the mold to create the desired feature.

14. The system of claim 13, wherein the ablative material is paint.

15. The system of claim 13, wherein the ablative material is a thin film.

16. The system of claim 13, further comprising a heater for heating the workpiece.

17. The system of claim 16, wherein the heater is a continuous wave laser.

18. The system of claim 16, wherein the workpiece is heated with a heating block or heating coil.

19. The system of claim 16, wherein the workpiece is heated prior to application of the laser pulse.

20. The system of claim 16, wherein the workpiece is heated during the application of the laser pulse.

21. The system of claim 13, wherein the confining medium is nearly optically transparent to the wavelength of the laser pulse.

22. The system of claim 21, wherein the confining medium is a liquid.

23. The system of claim 21, wherein the confining medium is glass.

24. The system of claim 13, wherein the controller further controls the pulse laser to generate a plurality of laser pulses that are applied to the ablative material.

25. The system of claim 24, wherein the fixture is further capable of moving the workpiece in an XY coordinate plane as the plurality of laser pulses are applied.

26. A method of forming a desired feature on a workpiece using a laser, the method comprising:
layering an ablative material on a surface of a mold that is opposite a mold surface having a desired feature;
applying a confining medium over the ablative material;
positioning the mold surface having the desired feature in proximity to a workpiece; and
applying a laser pulse to the ablative material, wherein the laser pulse ablates at least a portion of the ablative material and generates a shockwave that is applied to the mold and causes the mold to be directed into the workpiece to create the desired feature.

27. The method of claim 26, further comprising heating the workpiece prior to application of the laser pulse.

28. The method of claim 26, further comprising heating the workpiece during application of the laser pulse.
